(19) United States
(12) Patent Application Publication
(10) Pub. No.: US 2002/0004800 A1
(43) Pub. Date: Jan. 10, 2002

(54) Electronic notary method and system

(76) Inventors: Masahiro Kikuta, Tokyo (JP); Osamu Watanabe, Tokyo (JP)

Correspondence Address: Y. ROCKY TSAO, Fish & Richardson P.C., 225 Franklin Street, Boston, MA, 02110-2804, US

(21) Appl. No.: 09/902,309

(22) Filed: Jul. 10, 2001

(30) Foreign Application Priority Data
Jul. 10, 2000 (JP) 2000-208913

(51) Int. Cl. G06F 17/21

(52) U.S. Cl. 707/500

(57) ABSTRACT

In this invention, a member generates unique information of an electronic file to be notarized by using a member terminal. Upon identifying the member by signature input, a notary server stores the unique information and the identification information of the member in a database, together with a registration key, in correspondence with each other, and transmits the registration key ID to the member. When a general user wants to check notarization of the electronic file, he/she uses a general user terminal to generate unique information by using the electronic file, and transmits it to the notary server, together with the electronic file and acquired registration key ID. The notary server transmits notary information to the general user if the received unique information coincides with the unique information in the database.

### CROSS-REFERENCE TO RELATED APPLICATIONS

This application is based upon and claims the benefit of priority from the prior Japanese Patent Application No. 2000-208913, filed Jul. 10, 2000, the entire contents of which are incorporated herein by reference.

### BACKGROUND OF THE INVENTION

1. Field of the Invention

The present invention relates to an electronic notary system for notarizing an electronic document through a computer network such as the Internet.

2. Description of the Related Art

As is well known, contracts, business transactions, and the like through a computer network such as the Internet are becoming popular. Such use of networks is expected to become more popular. As one of the authentication techniques that support such use of networks, a technique using electronic signatures is available.

This technique using electronic signatures is a technique of guaranteeing the validity of digital information to be exchanged on a network by adding signature information to the digital information. For the above signature, public key cryptography is used. The validity of this public key is guaranteed by a third organization called a CA (Certificate Authority).

An example of this technique will be described below with reference to FIG. 1.

A signer (sender) generates a characteristic value from a document M to be sent by using a hash function h, and generates a signed document D(h(M)) by using a private key that the signer alone knows. The signer then sends the signed document D(h(M)) to a destination, together with the original document M.

The checker (receiver) decrypts the signed document D(h(M)) with the public key of the signer to obtain h(M). The checker also compresses the received original document M with the hash function h and compares the compression result h(M) with h(M) decrypted with the public key as described above to check whether the signature is authentic, thereby confirming the validity of the received document M.

In addition, as methods of identifying senders who send documents, authentication techniques such as iris authentication, voice print authentication, and signature authentication have also been developed.

An electronic document is electronically signed and guaranteed by using an authentication technique like one of those described above. This technique can prevent an ill-intentioned third party from disguising a signer and counterfeiting a document.

If, however, an authentic signer electronically signs a plurality of documents having different contents in the same business transaction, it is required to check which one of the documents is valid.

In addition, if there are a plurality of signed documents, e.g., wills, which cannot be authenticated by the signer himself/herself, it is impossible to check which one of the documents is valid.

### BRIEF SUMMARY OF THE INVENTION

It is an object of the present invention to provide an electronic notary system and method which can reliably notarize documents that are exchanged on a network.

In order to achieve the above object, according to claim 1 associated with the present invention, there is provided an electronic notary system comprising a notary server and first and second terminal apparatuses capable of performing network communication with the notary server, the first terminal including unique message generating means for generating message data unique to an electronic file designated by a user from the electronic file, input means for inputting first user identification information for identifying the user, and first terminal-side communication means for communicating with the notary server by establishing a communication link thereto by using second user identification information provided in advance from the notary server, transmitting at least the message data and first user identification information input from the input means to the notary server, and receiving a registration key, the notary server including first storage means for storing the first user identification information of the user and the second user identification information provided for the user in advance in correspondence with each other, first communication means for communicating with the first terminal-side communication means by establishing a communication link thereto when the second user identification information sent from the first terminal-side communication means coincides with the second user identification information stored in the first storage means, registration key generating means for generating a registration key upon reception of message data from the first terminal apparatus through the first communication means, and transmitting the registration key to the first terminal apparatus through the first communication means, and second storage means for storing the message data received through the first communication means in correspondence with at least the registration key and date information when the first user identification information received through the first communication means coincides with the first user identification information stored in the first storage means, the second terminal apparatus including unique message generating means for generating message data unique to an electronic file from the electronic file, and second terminal-side communication means for communicating with the notary server by establishing a communication link thereto, transmitting at least the message data and a registration key to the notary server, and the notary server including second communication means for communicating with the second terminal-side communication means by establishing a communication link thereto, and notary information generating means for, when the message data received through the second communication means coincides with message data stored in the second storage means and corresponding to a registration key received through the second communication means, generating notary information for certifying coincidence of the message data, and transmitting the notary information to the second terminal apparatus through the second communication means.

According to claim 12 associated with the present invention, there is provided an electronic notary method used for an electronic notary system including a notary server and first and second terminal apparatuses capable of performing network communication with the notary server, comprising the first storage step of causing the notary server to store first identification information of a user of the first terminal apparatus and second user identification information given to the user in advance in correspondence with each other, the unique message generating step of causing the first terminal apparatus to generate message data unique to an electronic file designated by the user from the electronic file, the reception step of causing the first terminal apparatus to receive first user identification information for identifying the user, the first communication link establishing step of causing the first terminal apparatus to transmit second user identification information, which is provided from the notary server in advance, to the notary server and establish the first communication link between the first terminal apparatus and the notary server when the second user identification information coincides with the second user identification information stored in the first storage step in the notary sever, the notary registration request step of causing the first terminal apparatus to transmit at least the message data generated in the unique message generating step and the first user identification information received in the reception step to the notary server through the first communication link, the registration key generating step of causing the notary server to generate a registration key upon reception of the message data from the first terminal apparatus through the first communication link and transmit the registration key to the first terminal apparatus through the first communication link, the second storage step of causing the notary server to store the message data received through the first communication link in correspondence with at least the registration key and date information when the first user identification information received through the first communication link coincides with the first user identification information stored in the first storage step, the unique message generating step of causing the second terminal apparatus to generate message data unique to an electronic file from the electronic file, the second communication link establishing step of causing the second terminal apparatus to perform communication by establishing a second communication link between the second terminal apparatus and the notary server, the notarization request step of causing the second terminal apparatus to transmit at least the message data and a registration key to the notary server through the second communication link, and the notary information generating step of causing the notary server to, when the message data received through the second communication link coincides with the message data stored in the second storage step and corresponding to the registration key received through the second communication link, generate notary information certifying the coincidence and transmit the notary information to the second terminal apparatus through the second communication link.

According to the electronic notary system and method with the above arrangement, when an electronic file is to be notarized/registered, the first terminal apparatus establishes a communication link with the notary server using user identification information provided in advance, generates message data unique to the electronic file to be notarized, and transmits it to the notary server.

Upon reception of message data from the first terminal apparatus, the notary server generates a registration key. If the notary server authenticates the user of the first terminal apparatus on the basis of first user identification information such as biometric information sent from the first terminal apparatus, the notary server stores the above registration key in correspondence with the electronic file.

When it is checked whether an electronic file at hand has been notarized, the second terminal apparatus generates message data unique to the above electronic file, and transmits the acquired registration key to the notary sever, together with the message data and electronic file.

The notary server then reads out message data corresponding to the received registration key. If this message data coincides with the message data received from the second terminal apparatus, the notary server generates notary information indicating the coincidence and transmits it to the second terminal apparatus.

According to the electronic notary system and method having the above arrangement, even if an ill-intentioned third party tries to disguise the user of the first terminal apparatus and notarize/register an electronic file, since the above identification information of the user and the first user identification information such as biometric information are required, unauthorized notarization/registration can be reliably prevented.

According to the electronic notary system and method with the above arrangement, an electronic file notarized by the notary server is a file that has undergone notarization whose authenticity is guaranteed like a notary certificate in the form of a paper medium which is notarized in a notary office. The user who has generated a notarization confirmation request can therefore receive a quick, accurate notary service through the network.

According to claim 3 associated with the present invention, there is provided an electronic notary system comprising a notary server and first and second terminal apparatuses capable of performing network communication with the notary server, the first terminal apparatus including input means for inputting first user identification information for identifying the user, transcript generating means for generating transcript information including an electronic file designated by the user, and first terminal-side communication means for communicating with the notary server by establishing a communication link thereto by using second user identification information provided in advance from the notary server, and transmitting at least the transcript information and first user identification information input from the input means to the notary server, the notary server including first storage means for storing the first user identification information of the user and the second user identification information provided for the user in advance in correspondence with each other, first communication means for communicating with the first terminal-side communication means by establishing a communication link thereto when the second user identification information sent from the first terminal-side communication means coincides with the second user identification information stored in the first storage means, request key generating means for generating a request key in correspondence with the electronic file included in the transcript information received through the first communication means, and third storage means for storing the electronic file included in the transcript information as a transcript file in correspondence with at least the request key and date information when the first user identification information received through the first communication means coincides with the first user identification information stored in the first storage means, the second terminal apparatus including second terminal-side communication means for communicating with the notary server by establishing a communication link thereto, and transcript request means for generating transcript request information including a request key and transmitting the transcript request information to the notary server through the second terminal-side communication means, and the notary server including second communication means for communicating with the second terminal-side communication means by establishing a communication link thereto, and transcript file transmission control means for reading out an electronic file corresponding to the request key included in the transcript request information received through the second communication means from the third storage means, and transmitting the electronic file to the second terminal apparatus through the second communication means.

According to claim 14 associated with the present invention, there is provided an electronic notary method used for an electronic notary system including a notary server and first and second terminal apparatuses capable of performing network communication with the notary server, comprising the first storage step of causing the notary server to store first user identification information of a user of the first terminal apparatus in correspondence with second user identification information provided for the user in advance, the reception step of causing the first terminal apparatus to receive the first user identification information for identifying the user, the transcript generating step of causing the first terminal apparatus to generate transcript information including an electronic file designated by a user, the first communication link establishing step of causing the first terminal apparatus to transmit the second user identification information provided from the notary server in advance to the notary server and establish the first communication link between the first terminal apparatus and the notary server when the second user identification information coincides with the second user identification information stored in the first storage step in the notary server, the transcript registration request step of causing the first terminal apparatus to transmit at least the transcript information generated in the transcript generating step and the first user identification information received in the reception step to the notary server through the first communication link, the request key generating step of causing the notary server to generate a request key upon receiving the transcript information from the first terminal apparatus through the first communication link, the third storage step of causing the notary server to store the electronic file included in the transcript information as a transcript file in correspondence with at least the request key and date information when the first user identification information received through the first communication link coincides with the first user identification information stored in the first storage step, the second communication link establishing step of performing communication by establishing a second communication link between the second terminal apparatus and the notary server, the transcript request step of causing the second terminal apparatus to generate transcript request information included in a request key and transmit the transcript request information to the notary server through the second communication link, and the transcript file transmission step of causing the notary server to read out an electronic file corresponding to the request key included in the transcript request information received through the second communication link from the information stored in the third storage step and transmit the electronic file to the second terminal apparatus through the second communication link.

According to the electronic notary system and method with the above arrangement, when an electronic file is to be registered as a transcript, the first terminal apparatus establishes a communication link with the notary server by using user identification information provided in advance and transmits an electronic file as a transcript to the notary server.

Upon reception of an electronic file from the first terminal apparatus, the notary server generates a request key. If the user of the first terminal apparatus is authenticated on the basis of first user identification information such as biometric information sent from the first terminal apparatus, the notary sever stores the request key in correspondence with the electronic file.

When an electronic file registered as a transcript is to be acquired, the second terminal apparatus transmits a request key to the notary server.

The notary server then reads out an electronic file corresponding to the received request key and transmits it to the second terminal apparatus.

According to the electronic notary system and method with the above arrangement, therefore, even if an ill-intentioned third party tries to disguise the user of the first terminal apparatus and register an electronic file as a transcript, since the above identification information of the user and the first user identification information such as biometric information are required, unauthorized transcript registration can be reliably prevented.

According to the electronic notary system and method with the above arrangement, an electronic file registered as a transcript in the notary server is a file that has undergone notarization whose authenticity is guaranteed like a notary certificate in the form of a paper medium which is registered as a transcript in a notary office. The user who requests a transcript can quickly and accurately receive a notary service through the network.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view for explaining an electronic signature technique;

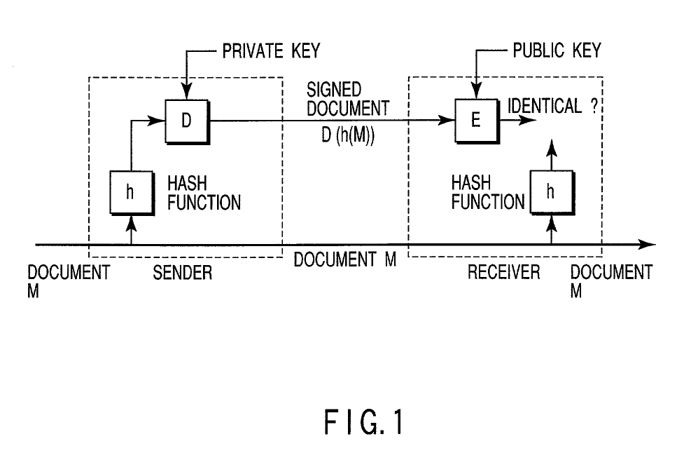

FIG. 2 is a view showing the arrangement of an electronic notary system according to an embodiment of the present invention;

FIG. 3 is a view for explaining registration processing for the notary information of an electronic file in the electronic notary system shown in FIG. 2;

FIG. 4 is a view for explaining notary confirmation processing for an electronic file in the electronic notary system shown in FIG. 2;

FIG. 5 is a view for explaining transcript registration processing for an electronic file in the electronic notary system shown in FIG. 2;

FIG. 6 is a view for explaining transcript transmission request processing for an electronic file in the electronic notary system shown in FIG. 2; and

FIG. 7 is a view for explaining transcript provision processing for an electronic file in the electronic notary system shown in FIG. 2.

### DETAILED DESCRIPTION OF THE INVENTION

An embodiment of the present invention will be described below with reference to the views of the accompanying drawing.

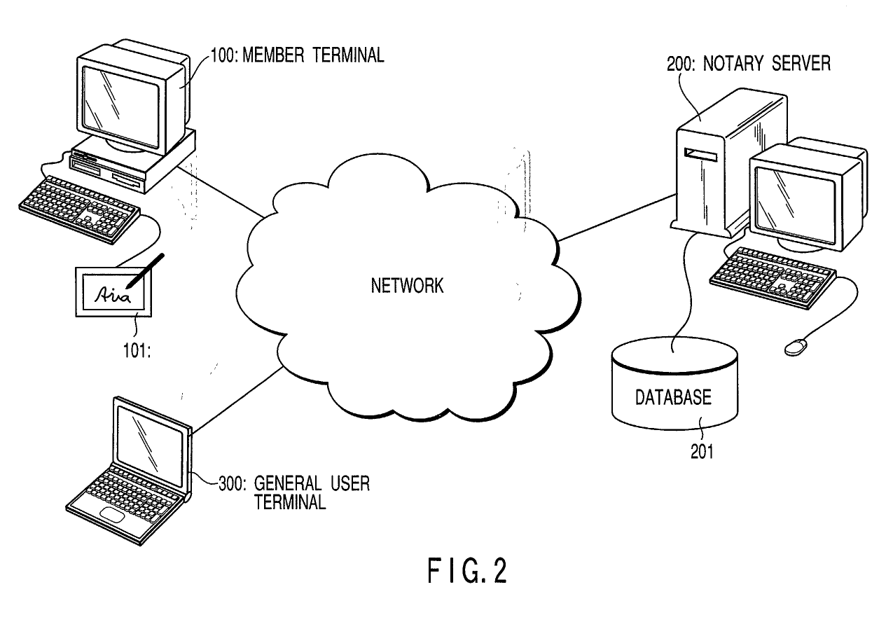

FIG. 2 shows the arrangement of an electronic notary system according to an embodiment of the present invention.

The electronic notary system is comprised of a member terminal 100, notary server 200, and general user terminal 300. They are connected to each other through a computer network such as the Internet.

The member terminal 100 is a personal computer used by a member who has gained membership in the notary service, and includes hardware for implementing network communication, electronic mail software for transmitting/receiving electronic mail to/from a mail server on the network, and browser software for browsing data stored in a Web server on the network. In the member terminal 100, client software specifically designed to receive the notary service is installed.

Note that the member terminal 100 has already acquired a digital certificate for identifying the member himself/herself on the network. The digital certificate has a basic format complying with, for example, ITU-T (Telecommunication Standardization Sector) X. 509, and is issued by a third party organization for providing authentication services.

The member terminal 100 also has a pad 101. The pad 101 is an input device for inputting a signature. The pad 101 converts a signature written on the panel with a dedicated pen into electronic data. The member terminal 100 then obtains the pressure and speed of the pen as signature information on the basis of the electronic data.

The notary server 200 is a server machine serving as an essential part of the notary service. The notary server 200 functions as a mail server and Web server and includes a database 201 in which digital certificates, signature information, electronic mail addresses, notarized/registered files, and various associated information can be recorded in correspondence with the account information of the respective members.

The notary server 200 also has the function of acquiring high-precision time information from the network, a GPS (Global Positioning System) satellite, a radio controlled watch, or the like.

The general user terminal 300 is a personal computer used by a general user who acquires an electronic file notarized by the notary service. The general user terminal 300 includes hardware for implementing network communication, electronic mail software for transmitting/receiving electronic mail to/from a mail server on the network, and browser software for browsing data stored in a Web server on the network.

In the general user terminal 300, client software for a notarization request or transcript request, which has been acquired from the above notary service, is installed in a recording medium such as a hard disk.

Note that the member terminal 100 in which the above client software is installed can substitute the general user terminal 300.

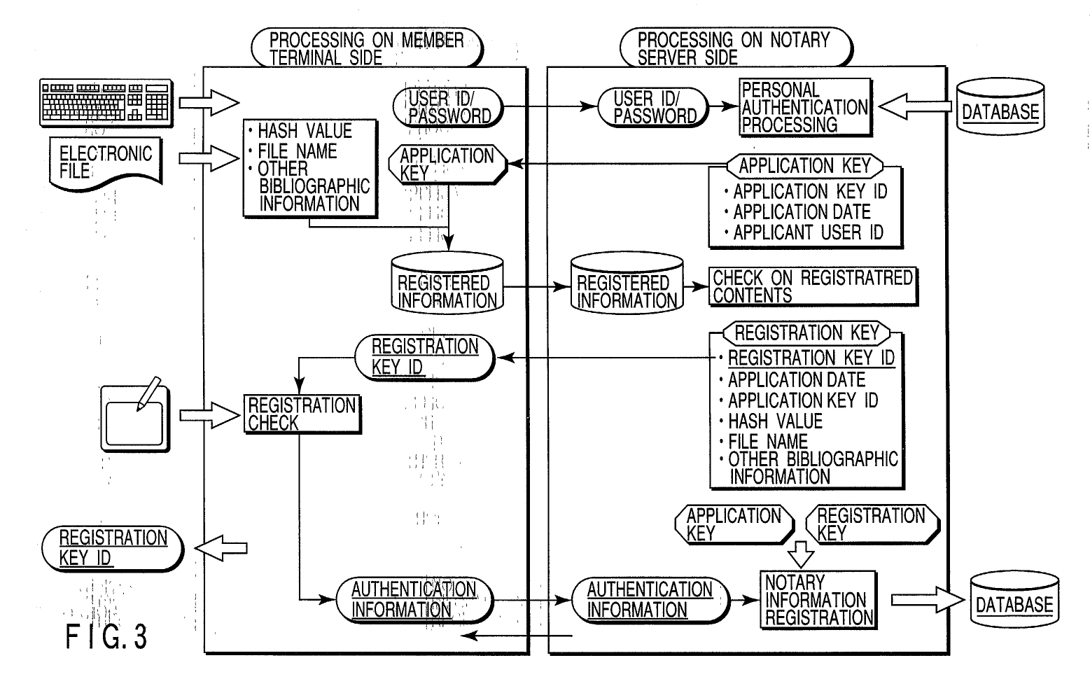

The operation of the electronic notary system having the above arrangement will be described next. Assume that a member who has been registered (has acquired an account) in the notary service wants to register the notary information of an arbitrary electronic file in the notary server 200 through the member terminal 100. This operation will be described first. FIG. 3 schematically shows the processing performed by the member terminal 100 and notary server 200 in this case.

First of all, when the member starts the client software in the member terminal 100, the member terminal 100 prompts the member to input the user name (to be referred to as a user ID hereinafter) and password which have been registered in the account when he/she gained membership in the notary service.

When the member inputs the user ID and password through the keyboard, the member terminal 100 executes log-in processing to establish a communication link with the notary server 200 through the HTTP (Hyper Text Transport Protocol) and transmit the user ID and password to the notary server 200.

Upon reception of the user ID and password, the notary server 200 verifies the received combination of user ID and password by referring to the member registration information registered in the database 201.

If it is confirmed by this verification that the received combination of user ID and password is valid, and the identification of the member is authenticated, the notary server 200 generates an application key.

This application key is constituted by an application ID for identifying the application key, a date (application time) when the member terminal 100 logged in, and the user ID of the member (applicant). The application key is sent to the member terminal 100.

Upon reception of the above application key, the member terminal 100 generates notary information about the electronic file to be notarized.

This notary information includes a fixed-length message generated by a message digest technique on the basis of the above electronic file, information about the electronic file (the file name, file size, latest update date, and comment), and information indicating the expiration date.

The following description will exemplify the case where the MD5 (Message Digest Algorithm 5) defined by, for example, RFC1321 is used as the message digest technique.

The MD5 is designed to generate 128-bit data (hash value) by arithmetic operation using a one-way hash function regardless of the length of original data. This hash value is the fixed-length message described above.

The notary information about the electronic file to be notarized, which is generated in this manner, is combined with the application key ID received from the notary server 200 to form one package, which is transmitted as registration information to the notary server 200.

Upon reception of the above registration information, the notary server 200 extracts the application ID from the information and verifies its validity.

If it is confirmed upon this verification that the extracted application key ID is valid, the notary server 200 generates a registration key on the basis of information in the above registration information.

This registration information consists of a registration key ID for identifying the registration key, the date (registration time) when the registration information was received from the member terminal 100, the above application key ID, the fixed-length message (hash value) of the electric file included in the above registration information, information about the electronic file (the file name, file size, latest update date, and comment), and information indicating the expiration date.

The notary server 200 transmits the registration key ID of the information the registration key to the member terminal 100.

Upon reception of the registration key ID, the member terminal 100 finally checks for the member whether the electronic file can be notarized. This check is made in accordance with the signature input from the pad 101.

When the signature is input through the pad 101, the member terminal 100 generates signature information on the basis of the signature, and transmits it as authentication information to the notary server 200.

Upon reception of the above authentication information, the notary server 200 determines whether the signature information of the signature input indicated by this authentication information is really made by the member himself/herself. In this determination processing, the notary server 200 determines the validity of the signature information by comparing it with the signature data of the member which is recorded on the database 201 in advance according to a predetermined algorithm.

If it is determined that the signature is made by the member himself/herself, the notary server 200 registers the above application key and registration key as notary information in the database 201, and disconnects the communication link from the member terminal 100, thereby terminating the processing.

The member terminal 100 stores the registration key ID received from the notary server 200.

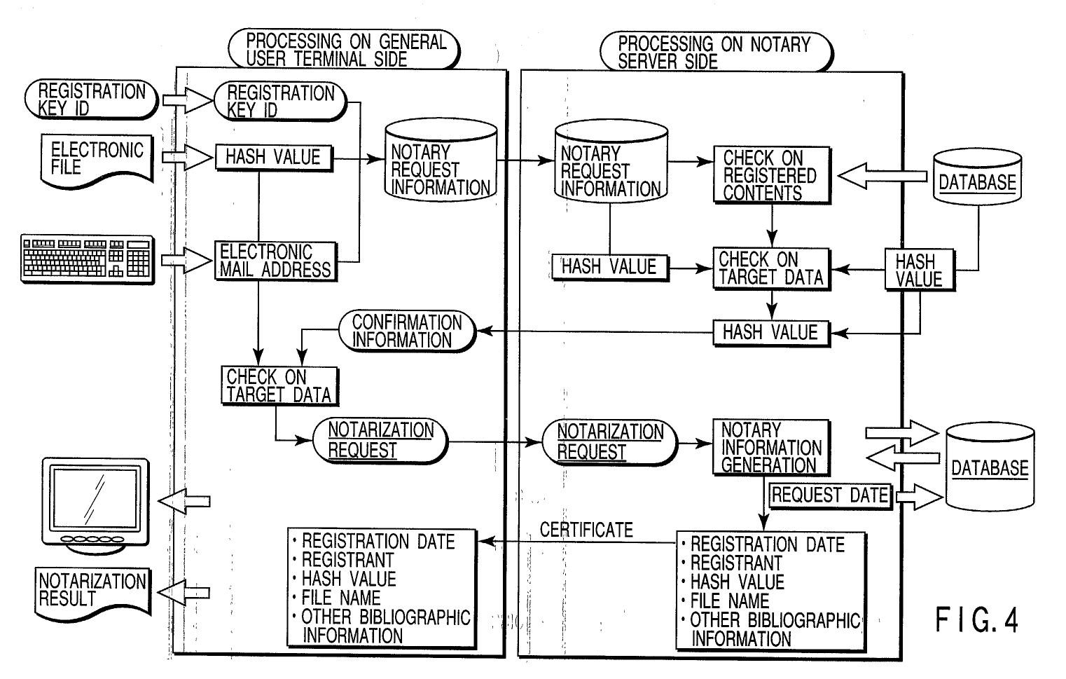

Assume that a general user who has obtained an electronic file and registration ID requests the notary server 200 through the general user terminal 300 to determine whether the above electronic file is notarized, and the notary server 200 performs the above determination. This operation will be described next. FIG. 4 schematically shows the processing performed by the general user terminal 300 and notary server 200.

Note that the notary server 200 grants connection upon reception of the connection request from the above terminal requesting the determination without imposing any specific limitation as long as the terminal has client software for general users installed therein.

A description of processing of establishing a communication link between the general user terminal 300 and the notary server 200 will be omitted from the following description, and processing after the establishment of the communication link will be described.

If a terminal that has not installed the above software generates a connection request, the notary server 200 prompts the terminal to download the above client software for general users, and provides the software for the terminal in accordance with the request.

First of all, a general user operates the general user terminal 300 to designate an electronic file for which he/she requests the notary service to check whether the file is notarized, a corresponding registration key ID, and an electronic mail address used for communication with the notary server 200.

The general user terminal 300 then obtains a hash value based on the MD5 on the basis of the electronic file designated by the general user, combines this hash value with the designated registration key ID and electronic mail address, and transmits the resultant information as notarization request information to the notary server 200.

Upon reception of the notarization request information, the notary server 200 extracts the hash value and registration key ID from the notary request information. The notary server 200 then checks whether the extracted registration key ID is registered as notary information in the database 201.

If it is determined that this information is registered, the notary server 200 reads out the hash value in the notary information corresponding to the registration key ID from the database 201, and checks whether the read hash value coincides with the hash value extracted from the notarization request information.

When the existence of the registration key ID and coincidence of the hash values are confirmed in this manner, the notary server 200 generates confirmation information indicating that these confirmations have been made, and transmits it to the general user terminal 300. In addition, the notary server 200 records the date of reception of the notarization request in the database 201.

Upon reception of the above confirmation information, the general user terminal 300 requests the notary server 200 to issue a certificate that certifies the validity of the electronic file (notarization request).

Upon reception of the notarization request, the notary server 200 generates a certificate for the electronic file on the basis of the notary information registered in the database 201. Note that this certificate contains bibliographic information such as the date of notary registration of the electronic file to be notarized, the name of the registrant (the name corresponding to the user ID), the file name, and the hash value.

The notary server 200 transmits the generated certificate to the general user terminal 300. The general user terminal 300 receives this. The processing is then terminated.

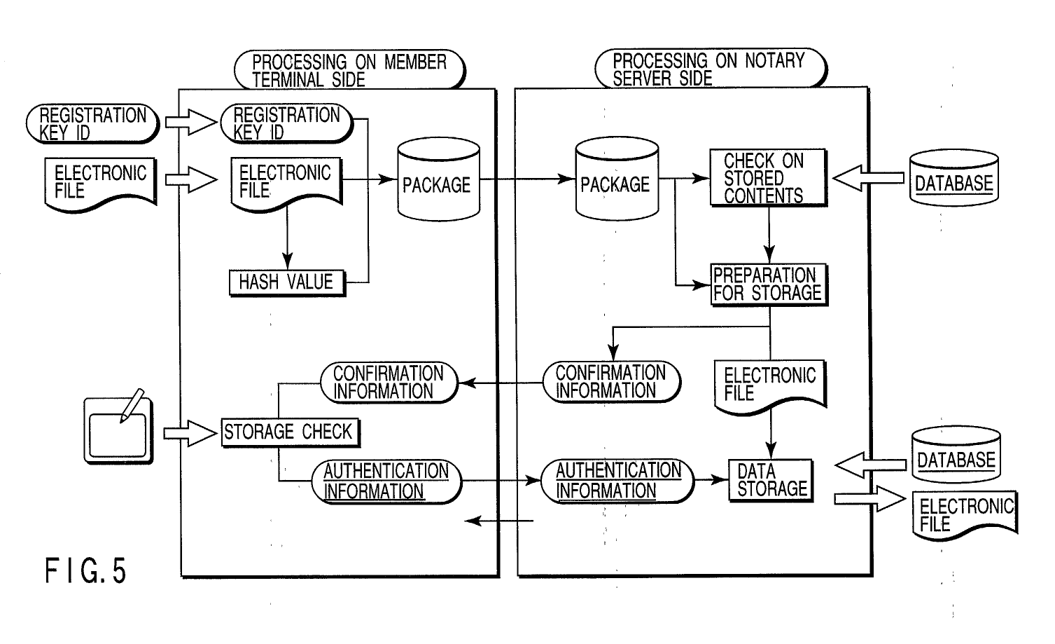

Assume that a member wants to register a transcript of an arbitrary electronic file in the notary server 200 through the member terminal 100. This operation will be described next. FIG. 5 schematically shows the processing performed by the member terminal 100 and notary server 200.

The processing of establishing a communication link between the member terminal 100 and the notary server 200 is the same as that described with reference to FIG. 3, and hence a description thereof will be omitted. Processing after the establishment of the communication link will be described below.

When the member operates the member terminal 100 to designate an electronic file to be registered as a transcript and a corresponding registration key ID (which has already been acquired by the processing shown in FIG. 3), the member terminal 100 obtains a hash value based on the MD5 from the electronic file, forms this hash value and the above electronic file and registration key ID into a package, and transmits it to the notary server 200.

Upon reception of the package, the notary server 200 checks the contents of this package as follows. The notary server 200 extracts the registration key ID and hash value from the package and checks whether \mathring{1} this registration key ID coincides with the registration key ID that is already registered in the notary server 200, \mathring{2} the registration key ID is registered by the member who generated the above transcript registration request, \mathring{3} the extracted hash value coincides with the hash value in the registration key corresponding to the registration key ID, and \mathring{4} this hash value coincides with the hash value based on the MD5, obtained from the electronic file extracted from the package.

If it is confirmed upon this check that all conditions \mathring{1} to \mathring{4} described above are satisfied, the notary server 200 performs preparatory processing for storage as follows. The notary server 200 temporarily stores the electronic file in the package, and generates confirmation information indicating that the electronic file corresponds to the registration key ID. The notary server 200 then transmits this information to the member terminal 100.

The member terminal 100 then finally checks with respect to the member whether the electronic file is to be registered as a transcript. This check is made by inputting a signature through the pad 101.

When the signature is input through the pad 101, the member terminal 100 generates signature information on the basis of this signature and transmits it as authentication information to the notary server 200.

Upon reception of this authentication information, the notary server 200 checks whether the signature information indicated by the authentication information is based on the signature of the member himself/herself. In this determination processing, the above signature information is compared with signature data registered in the database 201 in advance to determine its validity in accordance with a predetermined algorithm.

If it is determined that the information is based on the signature of the member himself/herself, the notary server 200 registers the temporarily stored electronic file as an authentic transcript in the database 201, notifies the member terminal 100 of the completion of the registration and disconnects the communication link, thus terminating the processing.

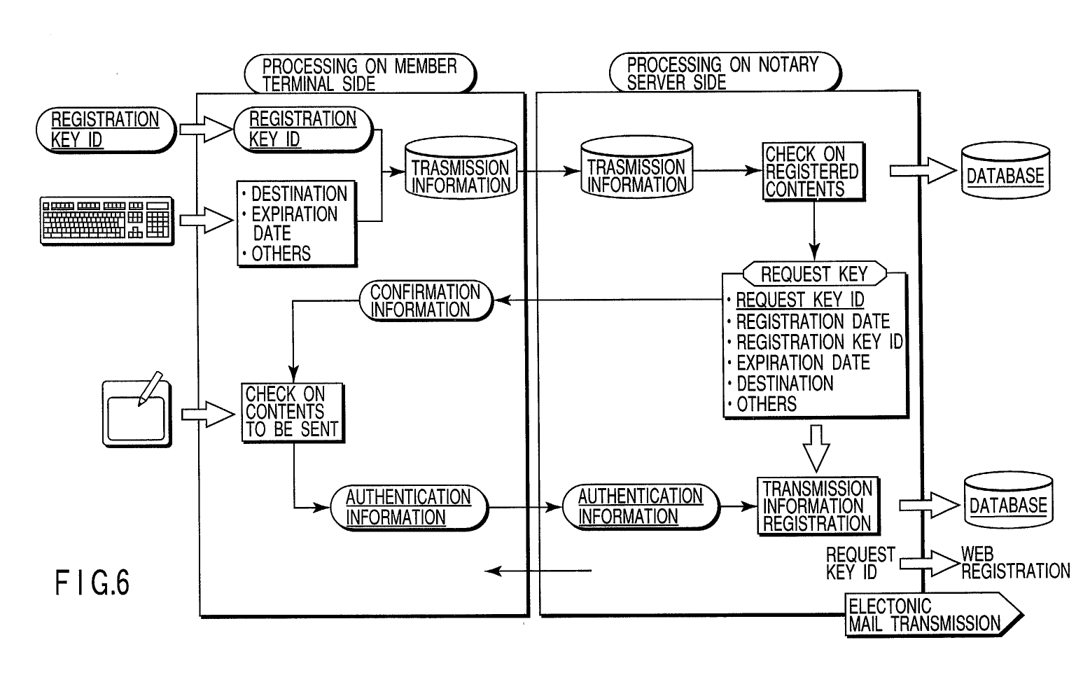

Assume that the member operates the member terminal 100 to make the notary server 200 transmit data for the reception of an electronic file registered as a transcript in the notary server 200 to the general user terminal 300 by electronic mail. This operation will be described next. FIG. 6 schematically shows the processing performed by the member terminal 100 and notary server 200.

The processing of establishing a communication link between the member terminal 100 and the notary server 200 is the same as that described with reference to FIG. 3, and hence a description thereof will be omitted. Processing after the establishment of the communication link will be described below.

When a communication link with the notary server 200 is established, the member terminal 100 generates transmission information by adding the electronic mail address of a general user who is permitted to acquire a transcript, an expiration date, and other control information to a stored desired registration key ID, and transmits the transmission information to the notary server 200.

Upon reception of the transmission information, the notary server 200 extracts the registration key ID from the transmission information, and checks whether this registration key ID \mathring{1} coincides with the registration key ID that is already registered in the notary server 200 and \mathring{2} is registered by the member who generated the above transcript registration request.

If it is confirmed upon the above check that both conditions \mathring{1} and \mathring{2} described above are satisfied, the notary server 200 generates a request key.

Note that this request key consists of a request key ID for identifying the request key, the date (registration date) when the transmission information was received from the member terminal 100, the registration key ID included in the transmission information, an electronic mail address (destination), an expiration date, and other control information.

If a plurality of electronic mail addresses are designated by the above transmission information, the notary server 200 generates request keys equal in number to the addresses.

The notary server 200 transmits the request key ID of the information in the request key, as confirmation information, to the member terminal 100.

Upon reception of the above confirmation information, the member terminal 100 finally checks with respect to the member whether the general user designated by the electronic mail address should be permitted to acquire a transcript of the electronic file.

This check is made by inputting a signature through the pad 101.

When a signature is input through the pad 101, the member terminal 100 generates signature information on the basis of this signature, and transmits it as authentication information to the notary server 200.

Upon reception of the above authentication information, the notary server 200 checks whether the signature information indicated by this authentication information is based on the signature of the member himself/herself. In this determination processing, the above signature information is compared with signature data registered in the database 201 in advance to determine its validity in accordance with a predetermined algorithm.

If it is determined that the information is based on the signature of the member himself/herself, the notary server 200 registers the above request key as transmission information in the database 201, and registers the request key ID on the corresponding Web site. The notary server 200 then notifies the member terminal 100 of the completion of the registration and disconnects the communication link. Note that the URL of the above Web site is uniquely set for each electronic mail address notified by the member terminal 100 (designated as a destination).

The notary server 200 also transmits electronic mail including the information of the URL corresponding to this electronic mail address to the electronic mail address, thus terminating the processing.

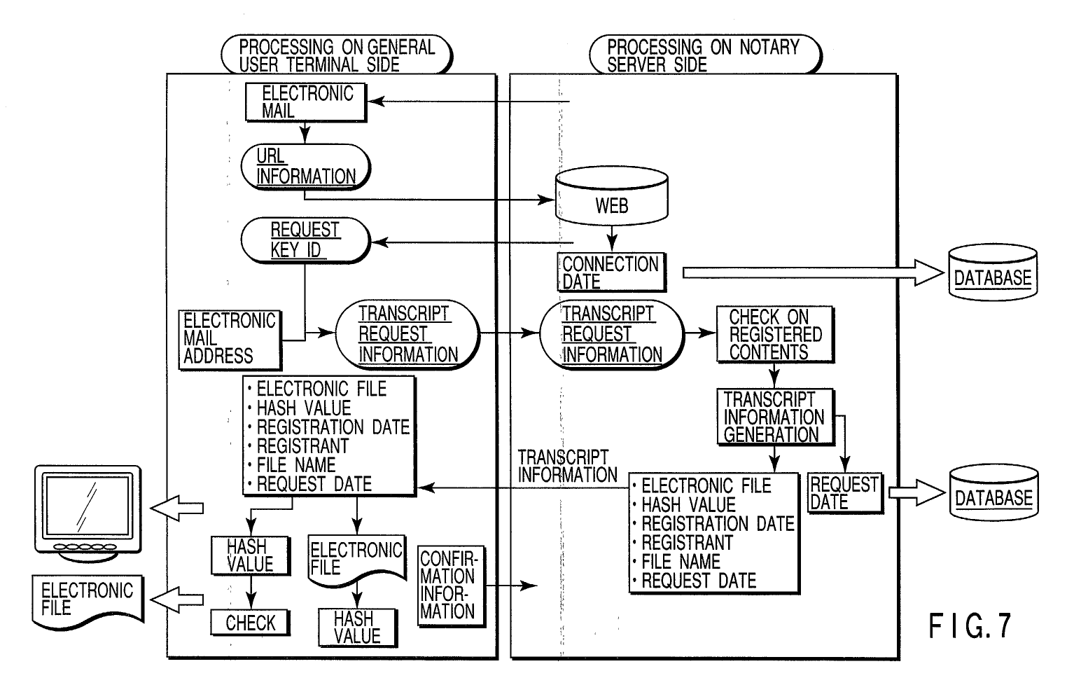

Assume that a general user wants to acquire an electronic file registered as a transcript in the notary server 200 through the general user terminal 300. This operation will be described next. FIG. 7 schematically shows the processing performed by the general user terminal 300 and notary server 200.

To acquire an electronic file registered as a transcript in the notary server 200, the registration key ID issued by the processing shown in FIG. 3 or the request key ID generated by the processing shown in FIG. 6 is required.

As a method of acquiring an electronic file, a method of directly acquiring an electronic file from a user who registered it as a transcript may be used. In the following description, however, this system uses a method of acquiring a request key ID from the Web site of the notary server 200, which is probably the most common method.

First of all, when the general user terminal 300 receives electronic mail transmitted from the notary server 200 by the processing shown in FIG. 6, the general user terminal 300 starts to browse a Web site corresponding to the URL written in the electronic mail by using the browser software. The general user terminal 300 then acquires a request key ID from the Web site.

As shown in FIG. 6, the Web site is set on the notary server 200. When the general user terminal 300 acquires a request key ID from the Web site, the notary server 200 records the date of acquisition in the database 201.

In response to the request from the general user, the general user terminal 300 forms the request key ID and self-electronic mail address into a package, and transmits it as transcript request information to the notary server 200.

Upon reception of the transcript request information, the notary server 200 extracts the request key ID and electronic mail address from the transcript request information. The notary server 200 then checks whether the extracted request key ID and electronic mail address are registered as transmission information in the database 201 in correspondence with each other.

If this registration is confirmed, the notary server 200 determines that the user of the request key ID is authentic. The notary server 200 then reads out an electronic file corresponding to the request key ID from the database 201 and generates a hash value based on the MD5 from this electronic file.

The notary server 200 packages information such as the above electronic file, the above hash value, the date of registration of the transcript of the electronic file, the registrant, the file name, and the request date, and transmits the package as transcript information to the general user terminal 300.

The general user terminal 300 extracts the electronic file from the received transcript information and generates a hash value based on the MD5 from the electronic file. The general user terminal 300 then compares the generated hash value with the hash value in the transcript information to check whether the reception has been normally performed.

If the normal reception is confirmed, the general user terminal 300 generates confirmation information indicating the confirmation of the reception, transmits it to the notary server 200, and disconnects the communication link from the notary server 200, thereby terminating the processing.

As described above, in the electronic notary system having the above arrangement, a network user (member) authenticated by the notary server 200 in advance generates information (hash value) unique to an electronic file to be notarized. If the above user is identified by signature input, the notary server 200 associates the unique information with the identification information of the user, stores them in the database 201, together with a registration key ID, and notifies only the above user of the registration key ID.

When a general user (or member) wants to check whether a given electronic file has been notarized, he/she generates a hash value from the electronic file, and transmits the hash value and the registration key ID acquired together with the electronic file to the notary server 200 via the network, thereby generating a confirmation request to check whether the electronic file has been notarized.

The notary server 200 then reads out a hash value corresponding to the received registration key ID from the database 201. If this hash value coincides with the hash value received from the user who has generated the notarization confirmation request, the notary server 200 generates notary information indicating the coincidence and transmits it to the user who generated the notarization confirmation request.

According to the electronic notary system having the above arrangement, even if an ill-intentioned third party disguises as a member and tries to notarize/register an electronic file, since he/she must input user identification information such as the user ID of the member, password, and signature input, unauthorized notary registration by disguising can be reliably prevented.

That is, an electronic file notarized by the notary server 200 is a file that has undergone notarization whose authenticity is guaranteed like a notary certificate in the form of a paper medium which is notarized in a notary office. The user who generates a notarization confirmation request can therefore receive a quick, accurate notary service through the network.

In recording the hash value of an electronic file as notary information in the database 201, the notary server 200 also records the information of the date of reception of a notary registration request from the member. Even if, therefore, the same member registers a plurality of files in association with the same transaction or the like, a valid electronic file can be identified from the request date.

According to the electronic notary system having the above arrangement, when a member requests notary registration by transmitting a notarized electronic file and its hash value to the notary server 200, the notary server 200 registers the received electronic file as a transcript upon identifying the member by signature input.

When the member requests the notary server 200 to send a transcript, the notary server 200 generates a Web site presenting a request key ID by which the above transcript can be acquired, and transmits electronic mail for sending the URL of the Web site to the electronic mail address designated by the above send request.

Upon reception of the above electronic mail, the network user (general user or member) browses the Web site by using the browser software to acquire the request key ID, and acquires the transcript by using this ID. The notary server 200 then records the date of acquisition.

According to the electronic notary system having the above arrangement, therefore, even if an ill-intentioned third party disguises as a member and tries to register an electronic file as a transcript, since he/she must input user identification information such as the user ID of the member, password, and signature input, unauthorized notary registration by disguising can be reliably prevented.

That is, an electronic file registered as a transcript by the notary server 200 is a file that has been registered as a transcript whose authenticity is guaranteed like a notary certificate in the form of a paper medium which is notarized in a notary office. The user who requests a transcript can quickly and reliably acquire the transcript through the network.

In providing notarization of an electronic file or a transcript of an electronic file, the notary server 200 records the date of reception of a notarization request or request to provide a transcript from a network user in the database 201, and hence can keep track of the generation of these requests. In addition, as described above, the notary server 200 may record the dates when a notary certificate is issued and a transcript is provided as well as the dates of reception of requests.

Note that the present invention is not limited to the above embodiment. For example, in the above embodiment, as shown in FIG. 5, an electronic file is registered as a transcript by the processing shown in FIG. 3 after notary registration is performed in advance. However, the present invention is not limited to this.

For example, in the processing shown in FIG. 3, the notary server 200 may issue a registration key ID when the member terminal 100 transmits registration information upon assembling an electronic file to be registered as a transcript therein, and predetermined conditions are satisfied.

Even in such an arrangement in which notary registration is not performed before registration of an electronic file as a transcript, it is impossible for an ill-intentioned third party to disguise as a member and register the electronic file as a transcript, and unauthorized transcript registration by disguising can be reliably prevented.

In the processing of providing the transcript in FIG. 7, the request key ID is acquired by referring to the Web site corresponding to the URL notified by the electronic mail, and the transcript is acquired by using this ID. However, the present invention is not limited to this.

For example, a transcript may be provided in accordance with a request from a network user who has acquired a registration key ID by some method. In this case, the user is requested to send a digital certificate authenticated by a third party and an electronic mail address, and a transcript is provided only when these pieces of information coincide with information about an authorized person which is stored in the database 201 in advance. This makes it possible to prevent unauthorized transcript acquisition. These settings may be arbitrarily made by the registrant of a transcript.

In the above embodiment, a member is authenticated on the basis of signature input through the pad 101. However, biometric authentication such as iris authentication, voice print authentication, or fingerprint authentication or personal authentication using IC cards may be used in place of the above authentication technique.

Furthermore, as the member terminal 100 and general user terminal 300, general personal computers can be used. The processing performed at each terminal described in this embodiment can be implemented by making the microprocessor built in each of the personal computers execute client software installed therein and using a network communication function.

Any person who possesses a personal computer capable of network communication can therefore receive the above notary service by only installing the above client software.

In the above embodiment, each client terminal as a member terminal or general user terminal operates on the basis of the client software installed in the hard disk.

Instead of this technique, for example, every time a request is generated by a client terminal, a notary server may provide a corresponding JAVA applet, and the client terminal may implement the same processing as that based on the client software on the basis of the provided applet. According to this arrangement, no client terminal needs to acquire client software and download it from a notary server.

In addition, an application key ID, registration key ID, and request key ID may be generated after they are encrypted by, for example, the RSA (Rivest-Shamir-Adleman) scheme. obviously, various changes and modifications can be made within the spirit and scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic notary system comprising a notary server and first and second terminal apparatuses capable of performing network communication with said notary server,
said first terminal including
unique message generating means for generating message data unique to an electronic file designated by a user from the electronic file,
input means for inputting first user identification information for identifying the user, and
first terminal-side communication means for communicating with said notary server by establishing a communication link thereto by using second user identification information provided in advance from said notary server, transmitting at least the message data and first user identification information input from said input means to said notary server, and receiving a registration key,
said notary server including
first storage means for storing the first user identification information of the user and the second user identification information provided for the user in advance in correspondence with each other,
first communication means for communicating with said first terminal-side communication means by establishing a communication link thereto when the second user identification information sent from said first terminal-side communication means coincides with the second user identification information stored in said first storage means,
registration key generating means for generating a registration key upon reception of message data from said first terminal apparatus through said first communication means, and transmitting the registration key to said first terminal apparatus through said first communication means, and
second storage means for storing the message data received through said first communication means in correspondence with at least the registration key and date information when the first user identification information received through said first communication means coincides with the first user identification information stored in said first storage means,
said second terminal apparatus including
unique message generating means for generating message data unique to an electronic file from the electronic file, and
second terminal-side communication means for communicating with said notary server by establishing a communication link thereto, transmitting at least the message data and a registration key to said notary server, and
said notary server including
second communication means for communicating with said second terminal-side communication means by establishing a communication link thereto, and
notary information generating means for, when the message data received through said second communication means coincides with message data stored in said second storage means and corresponding to a registration key received through said second communication means, generating notary information for certifying coincidence of the message data, and transmitting the notary information to said second terminal apparatus through said second communication means.

2. A system according to claim 1, wherein
said first terminal apparatus comprises transcript generating means for generating transcript information by integrating an electronic file designated by a user, message data generated on the basis of the electronic file, and a registration key corresponding to the electronic file, and transmitting the transcript information to said notary server through said first terminal-side communication means,
said notary server comprises
request key generating means for generating a request key in correspondence with information included in the transcript information received through said first communication means, and
third storage means for storing the electronic file included in the transcript information as a transcript file in correspondence with the request key when the message data included in the transcript information received through said first communication means coincides with message data stored in said second storage means and corresponding to the registration key included in the transcript information, and the first user identification information received through said first communication means coincides with the first user identification information stored in said first storage means,
said second terminal apparatus comprises transcript request means for generating transcript request information including a request key and transmitting the transcript request information to said notary server through said second terminal-side communication means, and
said notary server comprises transcript file transmission control means for reading out an electronic file corresponding to the request key included in the transcript request information received through said second communication means from said third storage means, and transmitting the electronic file to said second terminal apparatus through said second communication means.

3. An electronic notary system comprising a notary server and first and second terminal apparatuses capable of performing network communication with said notary server,
said first terminal apparatus including
input means for inputting first user identification information for identifying the user,
transcript generating means for generating transcript information including an electronic file designated by the user, and
first terminal-side communication means for communicating with said notary server by establishing a communication link thereto by using second user identification information provided in advance from said notary server, and transmitting at least the transcript information and first user identification information input from said input means to said notary server,
said notary server including
first storage means for storing the first user identification information of the user and the second user identification information provided for the user in advance in correspondence with each other,
first communication means for communicating with said first terminal-side communication means by establishing a communication link thereto when the second user identification information sent from said first terminal-side communication means coincides with the second user identification information stored in said first storage means,
request key generating means for generating a request key in correspondence with the electronic file included in the transcript information received through said first communication means, and
third storage means for storing the electronic file included in the transcript information as a transcript file in correspondence with at least the request key and date information when the first user identification information received through said first communication means coincides with the first user identification information stored in said first storage means,
said second terminal apparatus including
second terminal-side communication means for communicating with said notary server by establishing a communication link thereto, and
transcript request means for generating transcript request information including a request key and transmitting the transcript request information to said notary server through said second terminal-side communication means, and
said notary server including
second communication means for communicating with said second terminal-side communication means by establishing a communication link thereto, and
transcript file transmission control means for reading out an electronic file corresponding to the request key included in the transcript request information received through said second communication means from said third storage means, and transmitting the electronic file to said second terminal apparatus through said second communication means.

4. A system according to claim 2 or 3, wherein
said system further comprises a Web server which is located on the network and has a Web site from which the request key can be acquired, and
said notary server comprises URL information notification means for transmitting by electronic mail URL information of the Web site to an electronic mail address designated by said first terminal apparatus.

5. A system according to claim 2 or 3, wherein said system further comprises fourth storage means for, when said transcript file transmission control means transmits an electronic file to said second terminal apparatus, storing at least one of a time when transcript request information is received from said second terminal apparatus and a time when the electronic file is transmitted to said second terminal apparatus.

6. A system according to claim 1, wherein the first user identification information is biometric information of the user.

7. A system according to claim 3, wherein the first user identification information is biometric information of the user.

8. An electronic notary system comprising a notary server and a terminal apparatus capable of performing network communication with said notary server,
said terminal apparatus including
unique message generating means for generating message data unique to an electronic file designated by a user from the electronic file,
input means for inputting first user identification information for identifying the user, and
terminal-side communication means for communicating with said notary server by establishing a communication link thereto by using second user identification information provided in advance from said notary server, transmitting at least the message data and first user identification information input from said input means to said notary server, and receiving a registration key,
said notary server including
first storage means for storing the first user identification information of the user and the second user identification information provided for the user in advance in correspondence with each other,
communication means for communicating with said terminal-side communication means by establishing a communication link thereto when the second user identification information sent from said terminal-side communication means coincides with the second user identification information stored in said first storage means,
registration key generating means for generating a registration key upon reception of message data from said terminal apparatus through said communication means, and transmitting the registration key to said terminal apparatus through said communication means, and
second storage means for storing the message data received through said communication means in correspondence with at least the registration key and date information when the first user identification information received through said communication means coincides with the first user identification information stored in said first storage means.

9. An electronic notary system comprising a notary server and a terminal apparatus capable of performing network communication with said notary server,
said terminal apparatus including
unique message generating means for generating message data unique to an electronic file from the electronic file, and
terminal-side communication means for communicating with said notary server by establishing a communication link thereto, and transmitting at least the message data and a registration key to said notary server, and
said notary server including
storage means for storing the message data of the electronic file in correspondence with at least the registration key and date information,
communication means for communicating with said terminal-side communication means by establishing a communication link thereto, and
notary information generating means for, when the message data received through said communication means coincides with message data stored in said storage means and corresponding to a registration key received through said communication means, generating notary information for certifying coincidence of the message data, and transmitting the notary information to said terminal apparatus through said communication means.

10. An electronic notary system comprising a notary server and a terminal apparatus capable of performing network communication with said notary server,
said terminal apparatus including
input means for inputting first user identification information for identifying the user,
transcript generating means for generating transcript information including an electronic file designated by the user, and
terminal-side communication means for communicating with said notary server by establishing a communication link thereto by using second user identification information provided in advance from said notary server, and transmitting at least the transcript information and first user identification information input from said input means to said notary server,
said notary server including
first storage means for storing the first user identification information of the user and the second user identification information provided for the user in advance in correspondence with each other,
communication means for communicating with said terminal-side communication means by establishing a communication link thereto when the second user identification information sent from said terminal-side communication means coincides with the second user identification information stored in said first storage means,
request key generating means for generating a request key in correspondence with the electronic file included in the transcript information received through said communication means, and
second storage means for storing the electronic file included in the transcript information as a transcript file in correspondence with at least the request key and date information when the first user identification information received through said communication means coincides with the first user identification information stored in said first storage means.

11. An electronic notary system comprising a notary server and a terminal apparatus capable of performing network communication with said notary server,
said terminal apparatus including
terminal-side communication means for communicating with said notary server by establishing a communication link thereto, and
transcript request means for generating transcript request information including a request key and transmitting the transcript request information to said notary server through said terminal-side communication means,
said notary server including
storage means for storing an electronic file as a transcript file in correspondence with at least a request key and date information,
communication means for communicating with said terminal-side communication means by establishing a communication link thereto, and
transcript file transmission control means for reading out an electronic file corresponding to the request key included in the transcript request information received through said communication means from said storage means, and transmitting the electronic file to said terminal apparatus through said communication means.

12. An electronic notary method used for an electronic notary system including a notary server and first and second terminal apparatuses capable of performing network communication with the notary server, comprising:
the first storage step of causing the notary server to store first identification information of a user of the first terminal apparatus and second user identification information given to the user in advance in correspondence with each other;
the unique message generating step of causing the first terminal apparatus to generate message data unique to an electronic file designated by the user from the electronic file;
the reception step of causing the first terminal apparatus to receive first user identification information for identifying the user;
the first communication link establishing step of causing the first terminal apparatus to transmit second user identification information, which is provided from the notary server in advance, to the notary server and establish the first communication link between the first terminal apparatus and the notary server when the second user identification information coincides with the second user identification information stored in the first storage step in the notary sever;
the notary registration request step of causing the first terminal apparatus to transmit at least the message data generated in the unique message generating step and the first user identification information received in the reception step to the notary server through the first communication link;
the registration key generating step of causing the notary server to generate a registration key upon reception of the message data from the first terminal apparatus through the first communication link and transmit the registration key to the first terminal apparatus through the first communication link;
the second storage step of causing the notary server to store the message data received through the first communication link in correspondence with at least the registration key and date information when the first user identification information received through the first communication link coincides with the first user identification information stored in the first storage step;
the unique message generating step of causing the second terminal apparatus to generate message data unique to an electronic file from the electronic file;
the second communication link establishing step of causing the second terminal apparatus to perform communication by establishing a second communication link between the second terminal apparatus and the notary server;
the notarization request step of causing the second terminal apparatus to transmit at least the message data and a registration key to the notary server through the second communication link; and
the notary information generating step of causing the notary server to, when the message data received through the second communication link coincides with the message data stored in the second storage step and corresponding to the registration key received through the second communication link, generate notary information certifying the coincidence and transmit the notary information to the second terminal apparatus through the second communication link.

13. A method according to claim 12, wherein said method further comprises:
the transcript generating step of causing the first terminal apparatus to generate transcript information by integrating an electronic file designated by a user, message data generated on the basis of the electronic file, and a registration key corresponding to the electronic file and transmit the transcript information to the notary server through the first communication link;
the request key generating step of causing the notary server to generate a request key in correspondence with information included in the transcript information received through the first communication link;
the third storage step of causing the notary server to store an electronic file included in the transcript information corresponding to the request key when the message data included in the transcript information received through the first communication link coincides with the message data stored in the second storage step and corresponding to the registration key included in the transcript information, and the first user identification information received through the first communication link coincides with the first user identification information stored in the first storage step;
the transcript request step of causing the second terminal apparatus to generate transcript request information included in the request key and transmit the transcript request information to the notary server; and
the transcript file transmission step of causing the notary sever to read out the electronic file corresponding to the request key included in the transcript request information received by the second terminal apparatus from the information stored in the third storage step and transmit the electronic file to the second terminal apparatus.

14. An electronic notary method used for an electronic notary system including a notary server and first and second terminal apparatuses capable of performing network communication with the notary server, comprising:
the first storage step of causing the notary server to store first user identification information of a user of the first terminal apparatus in correspondence with second user identification information provided for the user in advance;
the reception step of causing the first terminal apparatus to receive the first user identification information for identifying the user;
the transcript generating step of causing the first terminal apparatus to generate transcript information including an electronic file designated by a user;
the first communication link establishing step of causing the first terminal apparatus to transmit the second user identification information provided from the notary server in advance to the notary server and establish the first communication link between the first terminal apparatus and the notary server when the second user identification information coincides with the second user identification information stored in the first storage step in the notary server;
the transcript registration request step of causing the first terminal apparatus to transmit at least the transcript information generated in the transcript generating step and the first user identification information received in the reception step to the notary server through the first communication link;
the request key generating step of causing the notary server to generate a request key upon receiving the transcript information from the first terminal apparatus through the first communication link;
the third storage step of causing the notary server to store the electronic file included in the transcript information as a transcript file in correspondence with at least the request key and date information when the first user identification information received through the first communication link coincides with the first user identification information stored in the first storage step;
the second communication link establishing step of performing communication by establishing a second communication link between the second terminal apparatus and the notary server;
the transcript request step of causing the second terminal apparatus to generate transcript request information included in a request key and transmit the transcript request information to the notary server through said second communication link; and
the transcript file transmission step of causing the notary server to read out an electronic file corresponding to the request key included in the transcript request information received through the second communication link from the information stored in the third storage step and transmit the electronic file to the second terminal apparatus through the second communication link.

15. A method according to claim 13 or 14, wherein
a Web server having a Web site from which the request key can be acquired is prepared on the network, and
the method further comprises the URL information notification step of causing the notary server to transmit by electronic mail URL information of the Web site to an electronic mail address designated by the first terminal apparatus.

16. A method according to claim 13 or 14, wherein said method further comprises the fourth storage step of, when an electronic file is transmitted to the second terminal apparatus in the transcript file transmission step, storing at least one of a time when transcript request information is received from the second terminal apparatus and a time when the electronic file is transmitted to the second terminal apparatus.

17. A method according to claim 12, wherein the first user identification information is biometric information of the user.

18. A method according to claim 14, wherein the first user identification information is biometric information of the user.
